(19) United States
(12) Patent Application Publication
(10) Pub. No.: US 2016/0271767 A1
(43) Pub. Date: Sep. 22, 2016

(54) Wrench with Adjustable Operating Angle

(71) Applicant: Hong Ann Tool Industries Co., Ltd., Taichung City (TW)

(72) Inventor: Cheng-Wei Su, Taichung City (TW)

(21) Appl. No.: 15/012,579

(22) Filed: Feb. 1, 2016

(30) Foreign Application Priority Data
Mar. 18, 2015 (TW) 104108627

(51) Int. Cl. B25B 23/00; B25G 1/06

(52) U.S. Cl. CPC B25B 23/0028; B25G 1/063

(57) ABSTRACT

A wrench includes a first member and a second member pivotally connected to the first member. The first member includes an engaging device having a biasing member, a first ball, a second ball, and a control member. One end of the biasing member biases against a bottom of the bore, and the other end of the biasing member biases against the first ball capable of abutting against the second ball. The control member is configured to exit or enter the first member. The second member includes a plurality of notches formed around an outer periphery thereof. When the control member exits the first member, the first ball biases against the second ball to abut against the second member. When the control member enters the first member, the control member abuts against the second ball to engage into one of the notches.

### BACKGROUND

The present invention relates to a wrench and, more particularly, to a wrench adapted to adjust an operating angle between a handle and a head.

Taiwan Utility Patent No. M489,729 discloses an angle control device for a wrench. The wrench body (10) includes a handle (11), and a connection head (12) formed at a front end of the handle (11). A front side of the connection head (12) has a slot (13) and is connected to a wrench head (40). A rear side of the wrench head (40) has a toothed portion (41) engaged with the slot (13) of the connection head (12). A pair of arms (14) located at two opposite sides of the slot (13) has corresponding axial holes (15). A rear end of the slot (13) has a recess (16) extending inwards therein. A side of the connection head (12) has a recess-hole (17) perpendicular and interconnected to the recess (16). A first spring (33) and a pressing-control member (30) are arranged into the recess-hole (17). A central portion of the pressing-control member (30) has a thin axial section (31). A rear end of the thin axial section (31) is a block portion (32). A second spring (23) and a detent (20) are arranged into the recess (16). The posterior of the detent (20) is a slotted portion (21) with a cavity (22) formed a side thereof. When the pressing-control member (30) and the detent (20) are engaged with each other, the thin axial section (31) of the pressing-control member (30) is able to move in relation to the slotted portion (21) of the detent (20). The block portion (32) of the pressing-control member (30) is engaged into the cavity (22) of the detent (20). Thus, when the connection head (12) is connected to the wrench head (40), the toothed portion (41) of the wrench head (40) is engaged with the detent (20). When the pressing-control member (30) is pressed inwards, the block portion (32) is disengaged from the cavity (22). The detent (20) is in a release state and is capable of moving relative to the recess (16). Thus, the wrench head (40) can be pivoted due to change an engaging relation between the toothed portion (41) and the detent (20), and implements an automatic relock after the pressing-control member (30) returning to an initial position under an elastic restoring force of the first spring (33).

However, the pressing-control member (30) and the detent (20) must be formed with special complicated shapes for implementing the relative movement. Hence, the pressing-control member (30) and the detent (20) with special shapes are difficult to process, and its structure is complicated to have a high malfunction rate.

Thus, a need exists for a novel wrench to mitigate and/or obviate the above disadvantages.

### BRIEF SUMMARY

This need and other problems in the field of wrenches are solved by a wrench including a first member and a second member. The first member extends along a first axis. The first member includes a first end and a second end spaced from the first end along the first axis. The first member is formed with a space and a bore at the first end. The bore is interconnected with the space and extends from the first end to the second end along the first axis. The first member further includes an engaging device having a biasing member, a first ball, a second ball, and a control member. The biasing member, the first ball, and the second ball are received into the bore. One end of the biasing member biases against a bottom of the bore, and the other end of the biasing member biases against the first ball capable of moving toward the first end along the first axis. The second ball is located adjacent to the first ball. The control member is configured to exit or enter the bore along a radial direction perpendicular to the first axis between a first position and a second position for selectively locking and releasing the first ball and the second ball.

The second member includes a connecting portion pivotally connected to the first end of the first member about a second axis disposed across the first axis. The connecting portion is mounted into the space and includes a plurality of notches formed around an outer periphery thereof. A plurality of flanges each is formed between two of the notches. A maximum radial distance defined between the second axis and one of the flanges is not less than a minimum radial distance defined between the second axis and one of the notches.

When the control member is in the first position and exits the bore, the first ball biases against the second ball under a biasing force of the biasing member to abut against the connecting portion of the second member;

When the control member is in the second position and enters the bore, the control member abuts against the second ball to engage into one of the notches.

Illustrative embodiments will become clearer in light of the following detailed description described in connection with the drawings.

### DESCRIPTION OF THE DRAWINGS

The illustrative embodiments may best be described by reference to the accompanying drawings where:

FIG. 1 is a perspective view of a wrench according to the present invention.

FIG. 2 is an exploded, perspective view of the wrench of FIG. 1.

FIG. 3 is a cross sectional view of the wrench of FIG. 1.

FIG. 4 is a continued view of the wrench of FIG. 3, and illustrates a control member in a first position.

FIG. 5 is a continued view of the wrench of FIG. 4, and illustrates a second member pivoted with respect to a first member to adjust an operating angle.

FIG. 6 is a continued view of the wrench of FIG. 3, and illustrates a control member in a second position.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “third”, “fourth”, “bottom”, “side”, “end”, “portion”, “section”, “spacing”, “length”, “depth”, “thickness”, and similar terms are used herein, it should be understood that these terms have reference only to the structure shown in the drawings as it would appear to a person viewing the drawings and are utilized only to facilitate describing the illustrative embodiments.

### DETAILED DESCRIPTION

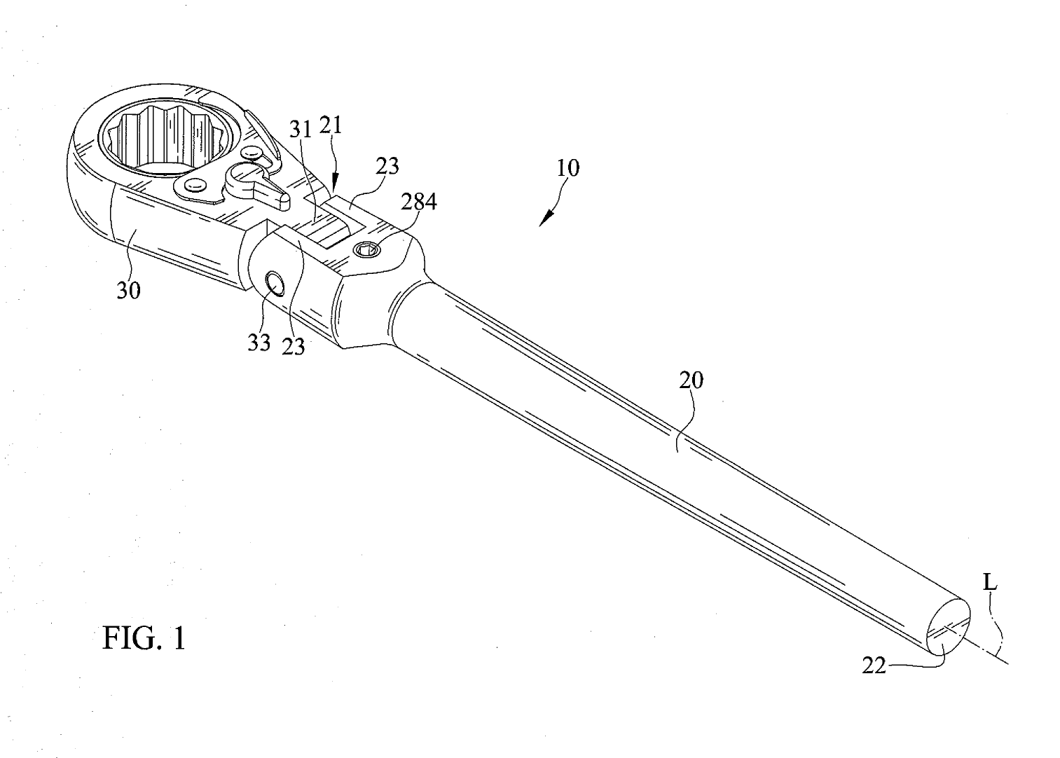

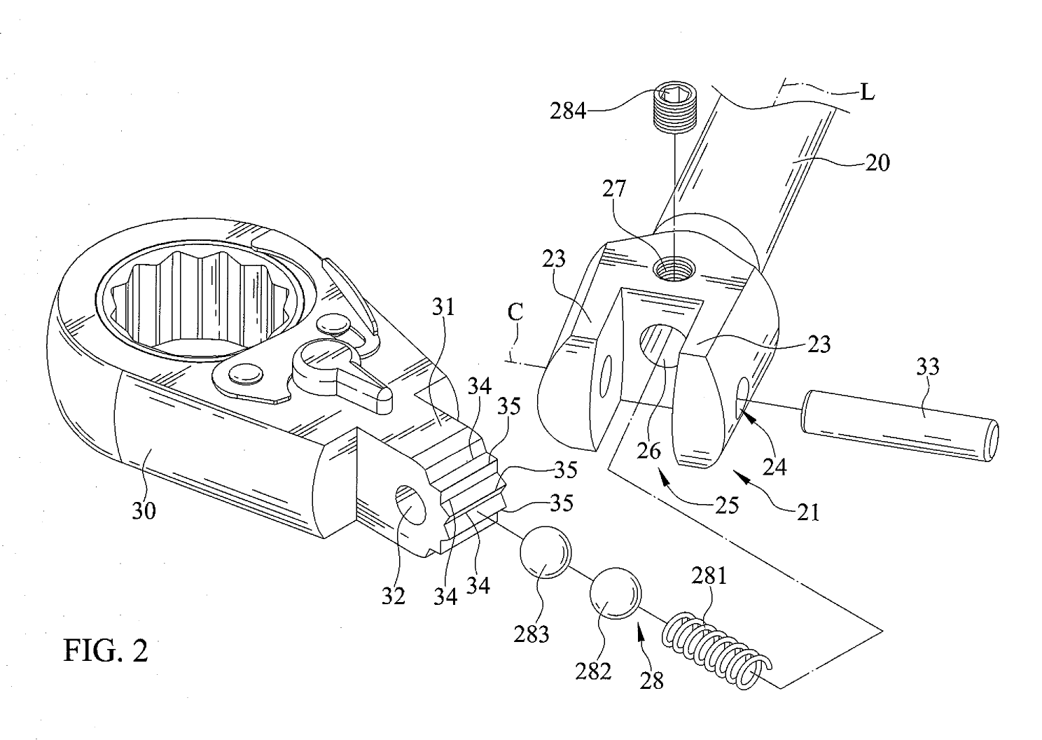

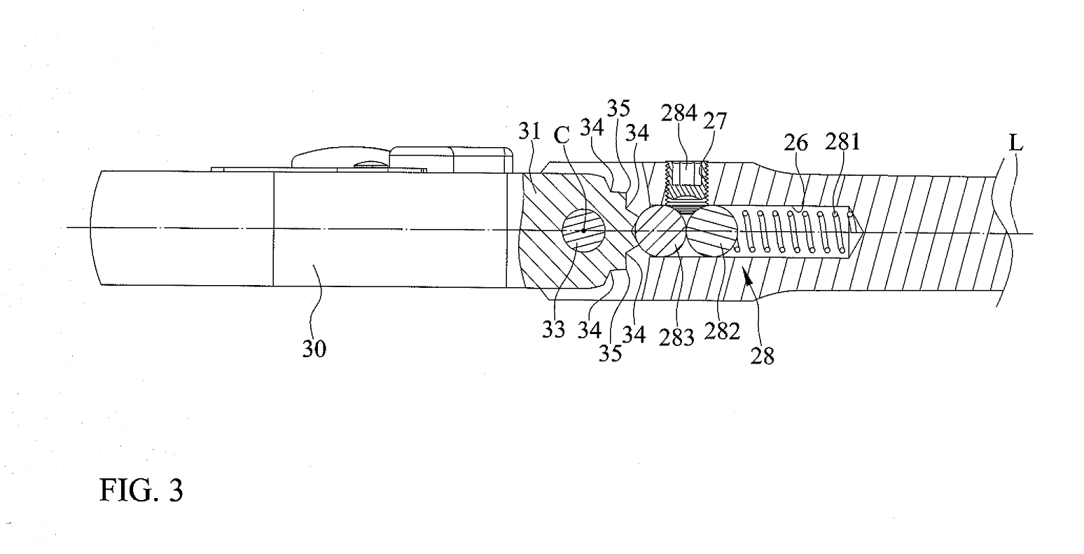

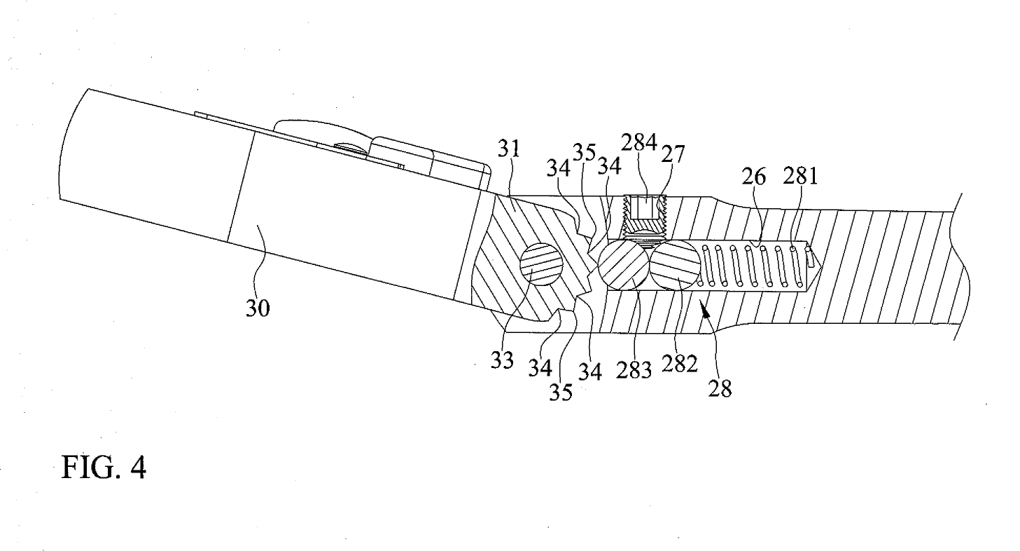

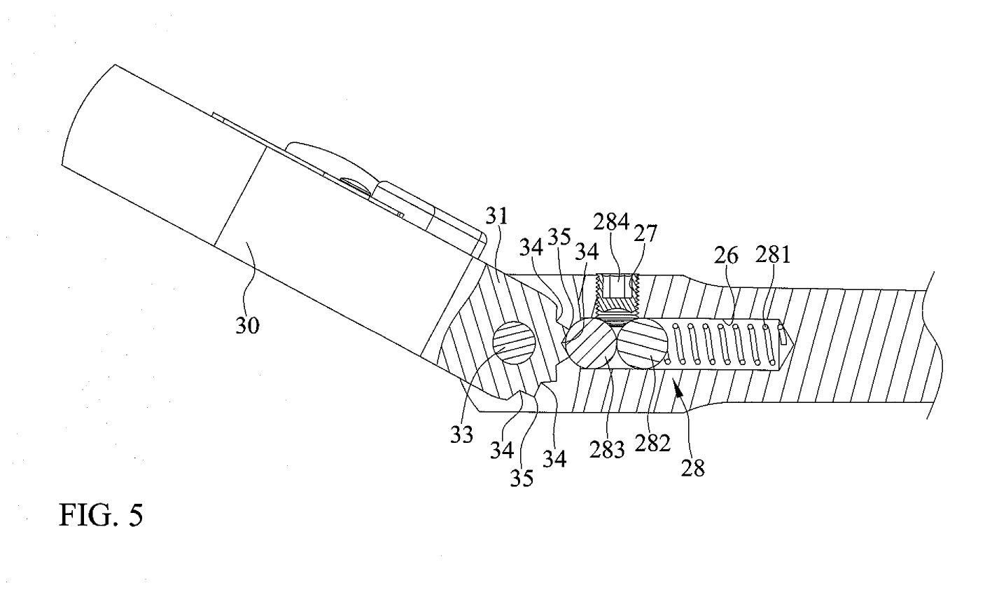

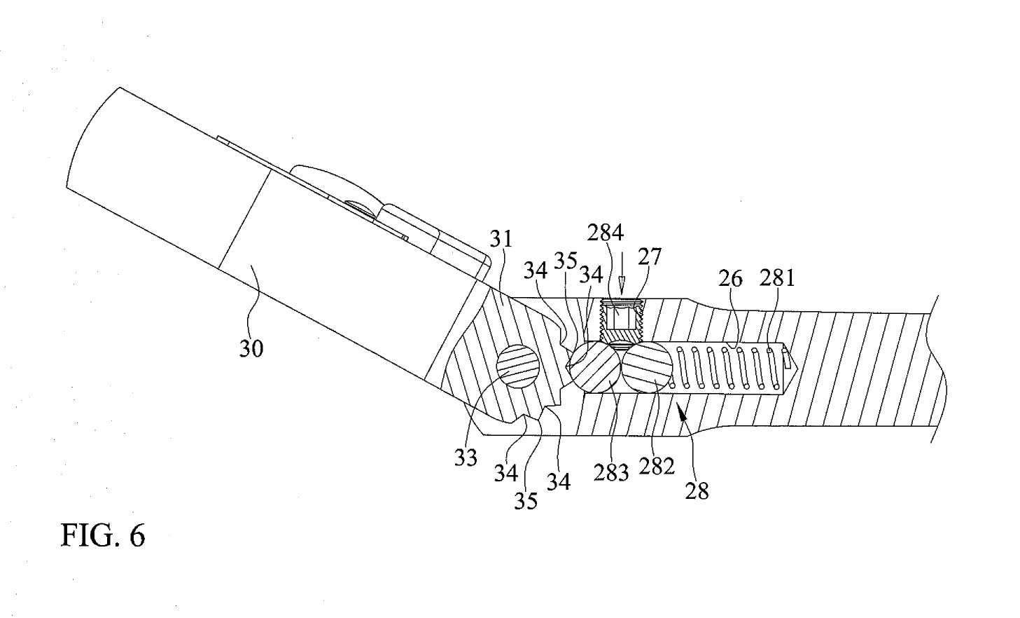

FIGS. 1-6 show a wrench according to the present invention. The wrench 10 includes a first member 20 and a second member 30 pivotally connected to the first member 20. In the embodiment, the first member 20 may be a handle adapted to be gripped by a user, and the second member 30 may be a driving head for driving a tool or a fastener.

The first member 20 extends along a first axis L. The first member 20 includes a first end 21 and a second end 22 spaced from the first end 21 along the first axis L.

The first member 20 includes a pair of lugs 23 formed at the first end 21 and a first hole 24 extending through the pair of lugs 23 along a second axis C disposed across the first axis L. In the embodiment, the first axis L and the second axis C are perpendicular to each other. The first hole 24 passes through the pair of lugs 23.

The first member 20 is formed with a space 25 and a bore 26 at the first end 21. The space 25 is formed between the pair of lugs 23 and is interconnected with the first hole 24. The bore 26 is interconnected with the space 25 and extends from the first end 21 to the second end 22 along the first axis L. In the embodiment, the bore 26 is a blind bore and has a circular cross-section.

The first member 20 includes a threaded aperture 27 extending along a radial direction perpendicular to the first axis L and interconnected between the bore 26 and outside of the first member 20.

The first member 20 further includes an engaging device 28, which has a biasing member 281, a first ball 282, a second ball 283, and a control member 284. The biasing member 281, the first ball 282, and the second ball 283 are received into the bore 26. One end of the biasing member 281 biases against a bottom of the bore 26, and the other end of the biasing member 281 biases against the first ball 282 capable of moving toward the first end 21 along the first axis L to push against the second ball 283. The second ball 283 is located adjacent to a side of the first ball 282 opposite to the biasing member 281. In the embodiment, the biasing member 281 is a coil spring, and the first and second balls 282 and 283 are both steel balls. The control member 284 is configured to exit or enter the bore 26 along the radial direction perpendicular to the first axis L between a first position and a second position for selectively locking or releasing the first ball 282 and the second ball 283. In the embodiment, the control member 284 includes a threaded portion adapted to engage with the threaded aperture 27, implementing it exits or enters the bore 26

The second member 30 includes a connecting portion 31 pivotally connected to the first end 21 of the first member 20 about the second axis C disposed across the first axis L. The connecting portion 31 is mounted into the space 25. The second member 30 includes a second hole 32 extending through the connecting portion 31 along the second axis C and a shaft 33 inserted into the first and second holes 24 and 33. The connecting portion 31 includes a plurality of notches 34 formed around an outer periphery thereof and a plurality of flanges 35 each formed between adjacent two of the notches 34. A maximum radial distance defined between the second axis C and one of the flanges 35 is not less than a minimum radial distance defined between the second axis C and one of the notches 34. In a preferred form, the notches 34 and the flanges 35 are interlaced with each other to form a toothed portion.

A sphere diameter of the first ball 282 is equal to a sphere diameter of the second ball 283, and a pitch distance defined between two adjacent flanges 35 is less than the sphere diameters of the first and second balls 282 and 283.

When the wrench 10 is in use, a user can adjust an operating angle between the first member 20 and the second member 30 according to different needs, preventing the wrench 10 to be intervened with other objects.

When the control member 284 is in the first position and exits the bore 26, the first ball 282 biases against the second ball 283 under a biasing force of the biasing member 281 to abut against the connecting portion 31 of the second member 30. The second member 30 can be discretionarily pivoted with respect to the first member 20. The operating angle between the first member 20 and the second member 30 may be slightly fixed due to the first ball 282 biasing against the second ball 283 under the biasing force of the biasing member 281 to abut against the connecting portion 31.

When the control member 284 is in the second position and enters the bore 26, the control member 284 abuts against the second ball 283 to engage into one of the notches 34 for effectively fixing the operating angle. Moreover, the control member 284 abuts against the first ball 282 moving towards the bottom of the bore 26 to compress the biasing member 281, so that the control member 284 is not intervened with the biasing member 281, providing a smooth operation of the engaging device 28.

In view of the foregoing, the wrench 10 according to the present invention has a more simple and effective structure for adjusting the operating angle.

Thus since the illustrative embodiment disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A wrench comprising:
a first member;
a second member pivotally connected to the first member;
a bore formed in one of the first member and the second member to receive an engaging device having a biasing member, a first ball, a second ball, and a control member, with one end of the biasing member biasing against a bottom of the bore, and the other end of the biasing member biasing against the first ball, with the second ball located adjacent to the first ball, with the control member configured to exit or enter the bore between a first position and a second position for selectively locking or releasing the first ball and the second ball; and
a connecting portion formed in the other one of the first member and the second member to selectively engage with the second ball, with the connecting portion including a plurality of notches formed around an outer periphery thereof, with a plurality of flanges each formed between adjacent two of the notches;
wherein when the control member is in the first position and exits the bore, the first ball biases against the second ball under a biasing force of the biasing member to abut against the connecting portion;
wherein when the control member is in the second position and enters the bore, the control member abuts against the second ball to engage into one of the notches.

2. The wrench as claimed in claim 1, wherein the first member extends along a first axis, wherein the first member includes a first end and a second end spaced from the first end along the first axis, wherein the first member is formed with a space and the bore at the first end, wherein the bore is interconnected with the space and extending from the first end to the second end along the first axis, wherein the biasing member biases against the first ball capable of moving toward the first end along the first axis, wherein the second ball is located adjacent to the first ball, wherein the control member is configured to exit or enter the bore along a radial direction perpendicular to the first axis.

3. The wrench as claimed in claim 2, wherein the second member formed with the connecting portion pivotally connected to the first end of the first member about a second axis disposed across the first axis, wherein the connecting portion is mounted into the space, and wherein a maximum radial distance defined between the second axis and one of the flanges is not less than a minimum radial distance defined between the second axis and one of the notches.

4. The wrench as claimed in claim 1, wherein a threaded aperture is interconnected between the bore and outside of one of the first member and the second member, and wherein the control member includes a threaded portion adapted to engage with the threaded aperture.

5. The wrench as claimed in claim 4, wherein when the control member is in the second position, the control member abuts against the first ball moving towards the bottom of the bore to compress the biasing member.

6. The wrench as claimed in claim 3, wherein the first member includes a pair of lugs formed at the first end and a first hole extending through the pair of lugs along the second axis, wherein the space is formed between the pair of lugs and is interconnected with the first hole, and wherein the second member includes a second hole extending through the connecting portion along the second axis and a shaft inserted into the first and second holes.

7. The wrench as claimed in claim 3, wherein the first axis and the second axis are perpendicular to each other, and wherein the notches and the flanges are interlaced with each other to form a toothed portion.

8. The wrench as claimed in claim 1, wherein the bore has a circular cross-section, and wherein the biasing member is a coil spring.

9. The wrench as claimed in claim 1, wherein a sphere diameter of the first ball is equal to a sphere diameter of the second ball, and wherein a pitch distance defined between two adjacent flanges is less than the sphere diameters of the first and second balls.
